(19) United States
(12) Patent Application Publication
(10) Pub. No.: US 2005/0039560 A1
(43) Pub. Date: Feb. 24, 2005

(54) Rack thruster comprising slide lining made of multi-layered material

(76) Inventors: Frederic C. Degorce, Blois (FR); Laura C. Irigoyen, Juarez (MX)

Correspondence Address: DOUGLAS D. FEKETE;DELPHI TECHNOLOGIES, INC., Legal Staff, Mail Code: 480-410-202, P.O. Box 5052, Troy, MI, 48007-5052, US

(21) Appl. No.: 10/917,833

(22) Filed: Aug. 13, 2004

(30) Foreign Application Priority Data
Aug. 22, 2003 (EP) 03292074.6

(51) Int. Cl. F16H 1/04; B62D 1/20

(52) U.S. Cl. 74/422

(57) ABSTRACT

A slide lining (9) for rack thruster (10) is dimensioned and shaped to come into contact with a steering rack (3) opposite to an operating pinion (4). The slide lining (9) is made of multi-layered material comprising a substrate layer intended to be bonded to a thruster body (8), an intermediate layer bonded to the substrate layer and an upper slide layer made of polymer composition with a low coefficient of friction. The intermediate layer forms raised structures which are distributed over the interface with the upper slide layer and are embedded in the said upper slide layer.

### TECHNICAL FIELD OF THE INVENTION

The present invention relates to a slide lining made of multi-layered material for a rack thruster, to a rack thruster intended to be housed in a rack steering-box casing to keep a rack in engagement with an operating pinion and to a rack steering-box including such a thruster. The invention is applied to rack steering-boxes of any type, mechanical, electrical, or hydraulic, for a motor vehicle.

### BACKGROUND OF THE INVENTION

In a rack steering-box, the rack thruster serves to compensate for faults and wear in the rack and the pinion so as to provide a substantially constant level of friction during use and prevent shocks between the pinion teeth and the rack, which would produce undesirable operating noise and be prejudicial to the operating quality of the steering system.

A rack thruster is known including a body onto which is fixed a slide lining made of multi-layered material shaped to come into contact with a face of the said rack opposite to the said pinion. In accordance with the prior art, the multi-layered material used is of the type known by the mark DU® or DU-B® made by Glacier Garlock Bearings®, including a metal support and a sintered bronze porous matrix impregnated and covered with a PTFE/lead friction mixture. This slide lining has the disadvantage of wearing fairly quickly, causing the appearance of operating noise necessitating maintenance operations on the steering-box. In addition, it contains lead, which is contrary to certain regulations for reasons of toxicity and pollution.

Such a slide lining is disclosed for example in U.S. Pat. No. 6,178,843. This lining also has a fairly complex geometry at the level of the surface turned towards the rack.

### SUMMARY OF INVENTION

The aim of the invention is to propose a rack thruster having an increased lifetime and satisfactory frictional characteristics, and which is also as simple as possible to manufacture.

To this end, the invention provides a slide lining made of multi-layered material for a rack thruster, dimensioned and shaped to come into contact with a steering rack on a face of the said rack opposite to an operating pinion, the said multi-layered material comprising a substrate layer intended to be bonded to a thruster body, an intermediate layer bonded to the substrate layer and an upper slide layer made of a polymer composition with a low coefficient of friction, characterised by the fact that the said intermediate layer forms raised structures which are distributed over the said substrate layer, project substantially perpendicularly to the said substrate layer and are embedded in the said upper slide layer.

Such multi-layered materials and the process for their manufacture are described in the patent U.S. Pat. No. 6,258,413, which is incorporated for reference in the present patent application.

The slide lining thus formed has been shown to have less rapid wear than the slide lining made of DU® of the prior art, without significant modification to the coefficient of friction.

The upper slide layer must have a low coefficient of friction, for example similar to that of PTFE. A number of polymers may be included in the composition of the upper slide layer, as described in patent U.S. Pat. No. 6,258,413. Preferably, the said upper slide layer is made with a fluoropolymer base. The upper slide layer can also include filler materials and/or adhesives.

Preferably, the said intermediate layer is made of a copper alloy, preferably bronze. As described in U.S. Pat. No. 6,258,413, the raised structures can be engraved using a calendaring roller in the intermediate layer as well as, optionally, on the surface of the substrate layer.

As described in U.S. Pat. No. 6,258,413, the raised structures can have many geometrical forms, in particular the form of ribs forming cells, contiguous or otherwise, for example polygonal, square, circular, or triangular cells. The raised structures can also have the form of discrete columns. Advantageously, the said raised structures have the form of ribs defining honeycomb cells.

As described in U.S. Pat. No. 6,258,413, different materials offering a sufficiently strong structure can be used as a substrate layer. Advantageously, the said substrate layer is made of steel.

In accordance with a particular embodiment of the invention, the said slide lining is made of multi-layered material of the family known by the mark NORGLIDE® PRO, manufactured by SAINT-GOBAIN PERFORMANCE PLASTICS. The NORGLIDE® PRO FAMILY includes different sub-families, such as BZ, XL, etc.

Advantageously, the said multi-layered material does not contain lead. Thus the toxicity and pollution problems inherent in the use and reprocessing of lead are avoided.

Preferably, the said slide lining has the form of a plate curved in an arc of circle and having a uniform radius of curvature over its contact surface. Thus, manufacture of the slide lining is effected easily and in precisely reproducible manner, for example by stamping in the press. However, other and in particular more complex geometrical forms, for example with radii of curvature differing from one zone to the other or broken arcs, can also be used.

The invention also provides a rack thruster intended to be housed in a casing of a rack steering-box to keep a rack engaged with an operating pinion, characterised by the fact that the said thruster includes a body on which the above-mentioned slide lining is fixed.

The invention also provides a rack steering-box for a motor vehicle, comprising a rack engaged with an operating pinion in a casing and a rack thruster so housed in the said casing as to apply a thrust to a face of the said rack opposite to the said pinion, characterised by the fact that the said rack thruster is of the above type.

### BRIEF DESCRIPTION OF DRAWINGS

The invention will be better understood and other aims, details, characteristics and advantages of it will become more clearly apparent in the course of the following description of a particular embodiment of the invention, given solely by way of illustration and in non-limiting manner, with reference to the attached drawings. In these drawings:

FIG. 1 is a partial view in section of a rack steering-box in accordance with an embodiment of the invention,

FIG. 2 is a perspective view of the rack thruster body in the steering-box of FIG. 1,

FIG. 3 is a perspective view of the slide lining of the rack thruster in the steering-box of FIG. 1,

FIG. 4 is an enlarged view in section showing the structure of the material of the slide lining of FIG. 3.

### DESCRIPTION OF PREFERRED EMBODIMENTS

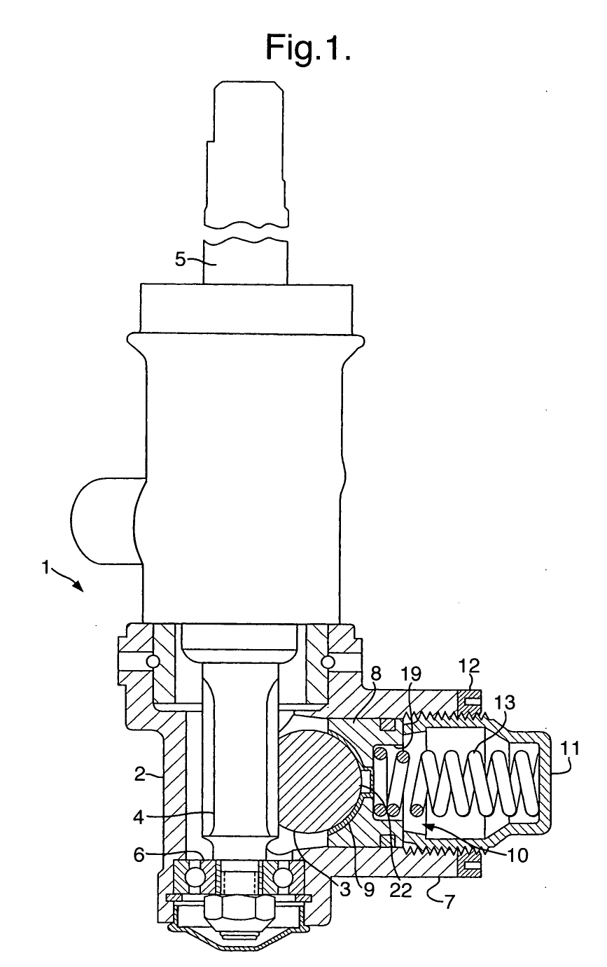

FIG. 1 shows in partial section a lower part 1 of a rack steering-box, which includes a casing 2 defining a generally tubular housing (not shown) for a rack 3, which extends perpendicularly to the plane of FIG. 1. FIG. 1 shows a central section of the rack 3, the two ends (not shown) of which are intended to be linked respectively to the track rods of the two steering road wheels of a vehicle, in accordance with the known technique. The casing 2 also contains an operating pinion 4 which engages with the rack 3 and which is linked in rotation to an intermediate shaft 5, the other end of which is intended to be linked to a driver's steering wheel (not shown). The end of the pinion 4 opposite to the shaft 5 is linked to a rotary bearing 6 fixed to the casing 2. Thus, rotation of the shaft 5 permits translation of the rack 3 in one direction or the other, perpendicularly to the plane of FIG. 1 by engagement with the pinion 4, so as to orient the steering road wheels of the vehicle. It is to be noted that known, hydraulic or electrical means, not shown, can be provided to assist displacement of the rack 3.

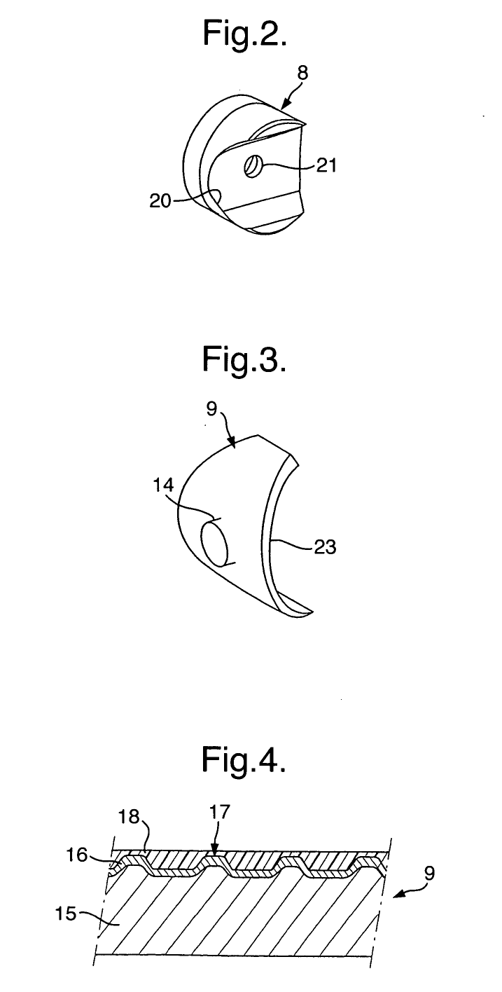

At the level of the pinion 4, and opposite to this relative to the rack 3, the casing 2 presents a tubular casing 7 defining a housing for a rack thruster 10, which presents a body 8 made of sintered steel, best seen in FIG. 2, and a slide lining 9 attached to the body 8 and shown in more detail in FIGS. 3 and 4. The casing 7 is closed at its end by a cover 11 which is screwed into the casing 7 and locked in position by a lock-nut 12 or any other fixing means (crimping, adhesion, etc.). A helical spring 13 bears on the cover 11 and on the bottom of the body 8 so as to thrust the thruster 10 against the rear face 22 of the rack opposite to the pinion 4. The rack thruster 10 and the spring 13 form an adjustment mechanism to ensure constant and optimal engagement between the rack 3 and the pinion 4, so as to compensate for their wear and absorb vibrations to avoid operating noise. The tension of the spring 13 and the clearance between the cover 11 and the thruster 10 can be adjusted by screwing the cover 11 to a lesser or greater extent into the casing 7.

With reference to FIG. 2, the body 8 of the rack thruster has a generally cylindrical external shape with a circular section having, on its lower face, a housing 19 which can be seen in FIG. 1 to receive an end of the spring 13 and, on its upper face, a cylindrical cavity 20 with a section in an arc of circle, the direction of the generatrix of which is perpendicular to the generatrix direction of the body 8. In the bottom of the cavity 20 is a fixing hole 21 which opens into the lower housing 19.

With reference to FIG. 3, the slide lining 9 of the rack thruster 10 has the form of a plate curved in an arc of circle and provided with a closed cylindrical nipple 14 projecting at the centre of its convex face. Having been shaped to fit exactly into the cavity 20, the lining 9 is fixed to the body 8 by insertion and expansion of the nipple 14 in the fixing hole 21 by means of a punch. The fixing hole 21 also centres the lining 9 on the body 8. Shapes other than an arc of circle can also be imparted to the lining 9 and to the cavity 20 which receives it, for example with a plurality of local radii of curvature.

The slide lining 9 is manufactured by cutting out and stamping a multi-layered laminate material of the type known by the mark NORGLIDE® PRO, manufactured by SAINT-GOBAIN PERFORMANCE PLASTICS, the structure of which is shown diagrammatically in FIG. 4. This material includes a substrate layer 15, covered by an intermediate layer 16, covered by a slide layer 18 with a polymer resin base. The upper surfaces of the substrate layer 15 and the intermediate layer 16 form projecting structures 17, for example ribs extending in a polygonal pattern, which are embedded in the slide layer 18 and covered by it. In this type of material, the metal structures bear the load and the slide layer has a low coefficient of friction.

### EXAMPLE

A slide lining 9 is manufactured from a multi-layered laminate material of the type known by the mark NORGLIDE® PRO, manufactured by SAINT-GOBAIN PERFORMANCE PLASTICS.

The substrate layer 15 is made of steel per DIN 1624-RRSt3-1.0347 (C 0.10%; Mn 0.2/0.4; RB 63) similar to the type 1008. The intermediate layer 16 is made of bronze CuSn6 per DIN 17662-CuSn6#2.1020 (Sn 6%). The combined thickness of layers 15 and 16 is 0.93 mm. The slide layer 18 is made of polytetrafluoroethylene (PTFE) with a portion of aromatic polyester (25% max.) and has a thickness of 0.07 mm. The nominal thickness of the material is 1.00 mm, with a tolerance of 0.96 to 1.00 mm. The projecting structures are ribs extending in a honeycomb pattern (hexagonal network), the dimensions of which are substantially those described in FIG. 3 in U.S. Pat. No. 6,258,413.

Before cutting out and stamping, the material is in the form of a sheet. The service temperature range of the material is −200° C. to +260° C. The maximum admissible load of the material is 200 MPa. As opposed to DU®, this material is lead-free.

### Comparative Example

The thruster 10 provided with the slide lining 9 in accordance with the above example was used in different tests of the steering-box. In a test of rotational load-free torque, the torque required to turn the shaft 5 and the pinion 4 was measured when the rack 3 bears no external load (no track-rods, no bellows). This test measures the frictional characteristics of the slide lining. All other things being equal, the result is 0.79 N.m with the lining 9 made of NORGLIDE® PRO against 0.73 N.m with a lining made of DU® of similar thickness (thickness of DU® between 0.965 and 1.005 mm). The observed increase in torque is not significant. The frictional characteristics of the two linings can be considered as substantially equivalent in this case.

In an endurance test, a machine simulates the use of the steering-box by operating the shaft 5 in such a manner as to perform 80 000 return cycles of the rack 3 from stop to stop. The wear of the slide lining is then measured. The result is 52μ with the lining 9 made of NORGLIDE® PRO against 79μ with a lining of the prior art made of DU®. The reduction in wear is spectacular, so that the lifetime of the NORGLIDE® PRO lining is distinctly longer and the appearance of operating noise is eliminated or at least delayed.

In conclusion, the use of a material of the NORGLIDE® PRO type instead of DU® for making the slide lining of a rack thruster provides significant reduction in the lining wear without significant modification of the coefficient of friction. Other materials could wear less, but would have a disadvantageous level of friction and/or a higher cost. In addition, this choice of material gives a lead-free slide lining.

In the embodiment illustrated, the rear face 22 of the rack 3 has a uniform circular section, for example with a radius of curvature of 11 mm subject to tolerances. The cavity 20 and the lining 9 are also uniformly curved and so dimensioned that the contact surface 23 of the lining 9 also has a radius of curvature of 11 mm subject to tolerances. Due to manufacturing tolerances, the contact zone between the slide lining 9 and the rack 3 is, depending on the tolerances, either over the surface, or rather in lines or band form. Whatever it may be, the selection of uniform circular curvature for the slide lining 9 facilitates its manufacture and has proved satisfactory for the NORGLIDE® PRO lining.

Although the invention has been described in connection with a particular embodiment, it is quite obvious that it is in no way limited to it and that it includes all the technical equivalents of the means described and their combinations if these fall within the framework of the invention.

1. A rack thruster for a rack steering-box to keep a rack in engagement with an operating pinion, said rack thruster comprising
a thruster body, and
a slide lining attached to said thruster body and dimensioned and shaped for engaging the rack opposite the operating pinion, said slide lining being composed of a multi-layered material comprising a substrate layer bonded to the thruster body, an intermediate layer bonded to the substrate layer and an upper slide layer overlying the intermediate layer and formed of a polymer composition having a low coefficient of friction,
said multi-layered material being further characterised in that the intermediate layer forms raised structures that are distributed over the surface of the intermediate layer adjacent the upper slide layer and project substantially perpendicularly to the intermediate layer so as to be embedded in the upper slide layer.

2. A rack thruster in accordance with claim 1, wherein the slide lining is further characterised in that the said upper slide layer is formed with a fluoropolymer base.

3. A rack thruster in accordance with claim 1, wherein the intermediate layer is made of copper alloy, preferably bronze.

4. A rack thruster in accordance with claim 1, wherein the raised structures have the form of ribs defining honeycomb cells.

5. A rack thruster in accordance with claim 1, wherein the substrate layer is made of steel.

6. A rack thruster in accordance with claim 1, wherein the multi-layered material is lead free.

7. A rack thruster in accordance with claim 1, wherein the slide lining is a plate having an arc shape characterised by a uniform radius of curvature over the contact surface engaging the rack.
